(19) United States
(12) Patent Application Publication
(10) Pub. No.: US 2006/0001219 A1
(43) Pub. Date: Jan. 5, 2006

(54) Oil supply

(76) Inventor: Michael Ofterdinger, Kressbronn (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/168,091

(22) Filed: Jun. 28, 2005

(30) Foreign Application Priority Data
Jul. 3, 2004 (DE) 10 2004 032 359.3

(51) Int. Cl. F16J 15/34

(52) U.S. Cl. 277/364

(57) ABSTRACT

A pressure oil feed, especially a pressure oil feed for conveying oil standing under pressure from rotating shafts (4) through a keyseat (8) into a stationary component (5), especially a housing 5 or the reverse, is proposed. Two sealing rings (1) are respectively provided on one side of the pressure oil feed or the keyseat (8) of the rotating shaft (4) and are joined together using elastic connection elements or connection bars (2, 2′) and are constructed as one seal.

The present invention concerns a pressure oil feed, especially a pressure oil feed for conveying oil standing under pressure from rotating shafts to a stationary component, or the reverse, in accordance with the preamble of patent claim 1.

According to the state of the art, with pressure oil feeds of this type, the oil is transferred through a borehole provided in the rotating shaft through a groove perforation into a corresponding borehole of the stationary component, e.g., a housing.

Further grooves are found on both sides of this perforation, in which the necessary sealing rings are situated. Here seals typically derived from motor construction, also called piston rings, are used. The piston rings used are interrupted at one point on the perimeter for purposes of installation and provided with various closing possibilities (thrust, lock), whereby they are usually made of metal or plastic.

The mode of function of the piston rings is as follows: the seal standing under pressure is fitted by the oil under pressure to the groove flank facing away from the pressure and to the housing borehole, whereby the forces arising on the flank, result from the pressure multiplied by the axial rectangular ring surface. The ring standing in the borehole forms a hydrodynamic lubricating film on the axial flank rotating with a differential velocity, similar to a sliding bearing. Here an oil leakage is generated, which depends upon the thickness of the lubricant film, the type of oil or the viscosity of the oil and its temperature. A generally recognized parameter for stress of a sealing ring is the so-called pxv value, which results from the product of the local pressure on the functional area and the sliding speed on the sealing radius.

In modern transmissions with ever higher pxv values, the limit of tolerance on the sealing flank can be exceeded, which can disadvantageously lead to impermissible temperature stresses or wear and tear phenomena on the seal/groove flank friction partners.

The present invention is based upon the objective of disclosing a pressure oil feed for conveying oil standing under pressure from rotating shafts into a stationary component, especially a housing or the reverse, in which the sealing ring stresses or the pxv value can be reduced under constant rotational speed and pressure conditions. Furthermore, manufacturing costs should be reduced and the necessary construction space should be minimized.

This objective is accomplished by the features of patent claim 1. Further refinements and advantages in accordance with the invention emerge from the dependent claims.

Accordingly, it is proposed to join the two sealing rings together, which are provided on both sides of the pressure oil feed or the groove perforation of the rotating shaft, using elastic connection elements or connection bars, and constructing them as one seal.

In accordance with a preferred embodiment of the present invention, the sealing rings are finished as a sealing ring composite constructed as a unit by machining or, for example, injection molded out of plastic.

Furthermore, it is possible to connect the sealing rings with one another through a prevulcanized or clipped-in elastomer.

Two complementing effects result through the conception of the invention. First, the tractive forces, resulting from the elastic connections, reduce surface pressures on the groove flanks and the pxv value can therewith be reduced; secondly, the surfaces facing the pressure are reduced by the connection elements, owing to which the surface stresses on the flanks are, likewise, reduced. In accordance with the invention, the oil can flow through unimpeded between the connection bars between the two sealing rings.

Moreover, connecting the sealing rings with one another by clipped-in tension springs is provided in the framework of a further especially advantageous embodiment of the invention.

There are numerous possibilities for adapting to various operating possibilities through the variation of shape, size and number of the elastic intermediate elements, in which the elastic component acts as a relatively constant force and the surface component acts as a force linearly depending upon the pressure.

In accordance with the invention, the seal of the invention can be accommodated or arranged directly in the keyseat of the feed, owing to which the two conventional sealing grooves are advantageously dispensed with, so that the manufacturing expenditure and costs can be significantly reduced. In this way, shafts can also be configured shorter, which can also have an influence on the construction size of the entire unit. The seal can be interrupted at a site on the perimeter for assembly purposes and are provided with various closing possibilities (thrust, lock).

The invention is described in greater detail below on the basis of the appended Figures, wherein:

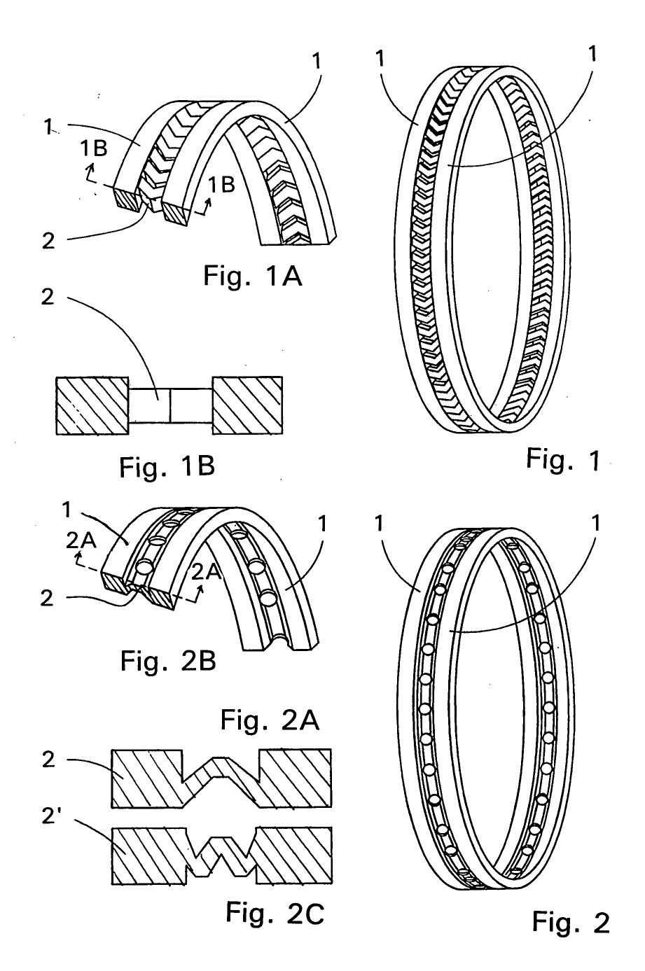

FIG. 1 is a perspective view of a first preferred embodiment of the seal of a pressure oil feed in accordance with the invention;

FIG. 2 is a perspective view of a second preferred embodiment of the seal of a pressure oil feed in accordance with the invention;

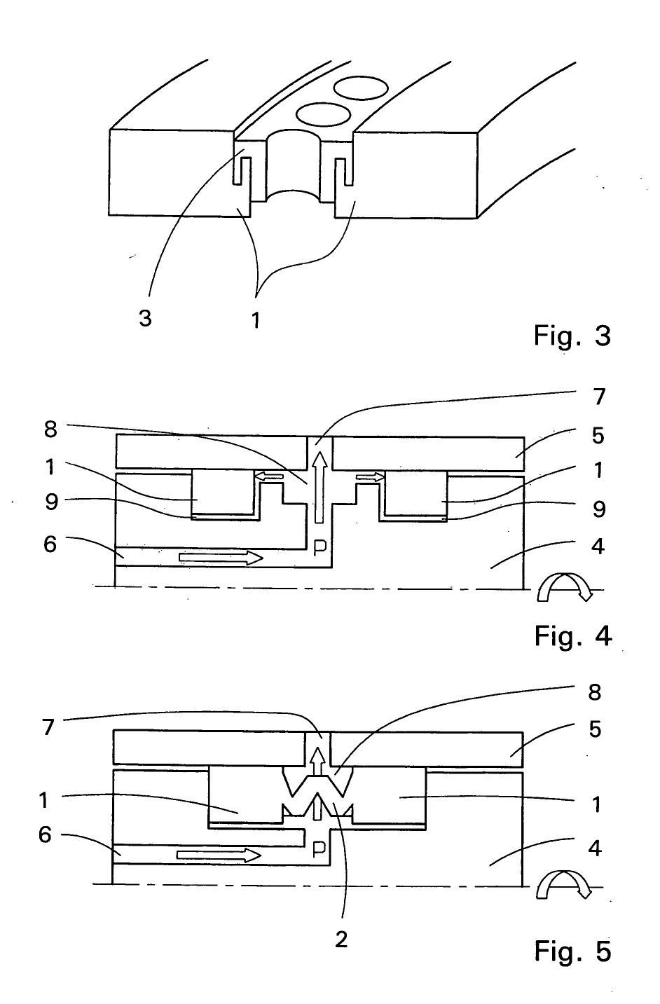

FIG. 3 is a view of a further preferred embodiment of the seal of a pressure oil feed in accordance with the invention;

FIG. 4 is a schematic view of the arrangement of the seal according to the state of the art;

FIG. 5 is a schematic view of the arrangement of the seal in accordance with the present invention; and

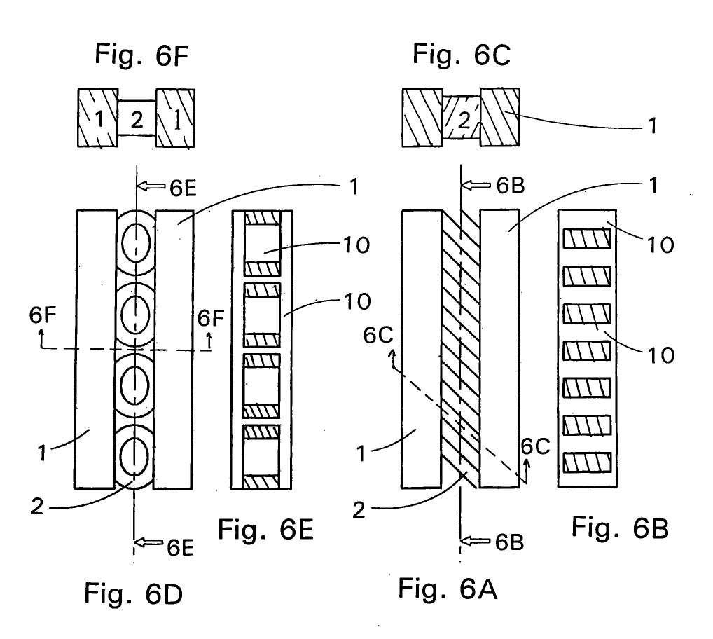

FIG. 6 is a schematic view of two embodiments of the present invention, which illustrate the reduction of the surfaces subjected to pressure.

In accordance with the invention, the two sealing rings, which are respectively provided on one side of the pressure oil feed or the groove perforation (keyseat) of the rotating shaft, are assembled using elastic connection elements and constructed as one seal for reducing the surface pressures on the groove flanks as well as for reducing the surfaces facing the pressure.

In this connection, the sealing rings can be constructed as a sealing ring composite constructed as a unit by cutting or, for example, be injection molded out of plastic so that one sealing ring arises. Two embodiments of a seal or a sealing ring composite constructed in this way are represented in FIGS. 1 and 2, which differ in the shape of the connection bars. Sealing rings are designated with 1 and connection bars between the seals 1 are designated with 2 in the Figures. Furthermore, the Figures contain a side view of the connection bars 2. An exact adaptation to different operating conditions can take place through the variation of shape, size and number of elastic connection bars 2. For example, the elasticity can be increased by providing a connection bar designated by 2′ in FIG. 2.

A further possibility of assembling the sealing rings 1 consists of connecting the sealing rings 1 by a prevulcanized or clipped-in elastomer 3. This embodiment is the object of FIG. 3.

FIGS. 4 and 5 represent a schematic view of the arrangement of a seal in connection with a pressure oil feed, according to the state of the art or in accordance with the present invention. A rotating shaft, whose direction of rotation is indicated by the arrow, is designated with 4 and a housing with 5. The oil is passed under a pressure p through a borehole 6 in the interior of the shaft 4 through a groove perforation or a keyseat 8 through a borehole 7 of the housing 5 into the housing 5.

The seal of the invention is accommodated directly in the keyseat 8 of the oil feed, as is apparent from FIG. 5, owing to which two conventional sealing ring grooves 9, which are necessary according to the state of the art in accordance with FIG. 4, are advantageously dispensed with. This also results in a possible construction space savings in addition to reducing the manufacturing and cost expenditure, since shafts can be configured shorter.

The schematic representation in accordance with FIG. 6 illustrates the reduction of the surfaces subjected to pressure, attainable in accordance with the invention by connection bars 2. A plan view and a side view in the direction of the acting pressure are respectively shown for two differently configured embodiments. In this connection, darkly hatched surfaces 10 are the surfaces subjected to pressure. The connection bars 2 are dimensioned larger in connection with the embodiment represented on the right so that the surface subjected to pressure is more reduced, which also leads to correspondingly less stress on the groove flank.

### REFERENCE NUMERALS

1 sealing ring
2 connection bar
2′ connection bar
3 elastomer
4 shaft
5 housing
6 borehole
7 borehole
8 keyseat
9 sealing ring groove
10 surface subjected to pressure
p pressure

1-8. (canceled)

9. A pressure oil feed for conveying oil standing under pressure between rotating shafts (4) through a keyseat (8) into a stationary component (5), especially a housing, including two sealing rings which are respectively provided on one side of a pressure oil feed or the keyseat (8) of the rotating shaft, the two sealing rings (1), that are respectively provided on one side of the pressure oil feed or the keyseat (8) of the rotating shaft, are joined together using one of elastic connection elements or connection bars (2, 2′) and are constructed as one seal.

10. The pressure oil feed according to claim 9, wherein the sealing rings (1) are finished as a sealing ring composite constructed as a unit by one of machining or are injection molded.

11. The pressure oil feed according to claim 10, wherein the sealing rings (1) are injection molded out of plastic.

12. The pressure oil feed according to claim 9, wherein the sealing rings (1) are connected with one another through one of a prevulcanized and a clipped-in elastomer (3).

13. The pressure oil feed according to claim 9, wherein the sealing rings (1) are connected with one another through clipped-in tension springs.

14. The pressure oil feed according to claim 9, wherein the seal is one of directly accommodated and arranged in the keyseat (8) of the pressure oil feed.

15. The pressure oil feed according to claim 9, wherein the seal is interrupted at a site on the perimeter for assembly and is provided with various closing possibilities.

16. The pressure oil feed according to claim 9, wherein an adaptation to different operating conditions is attainable by one or more of variation of shape, size and number of elastic connection bars (2, 2′).
